(19) United States
(12) Patent Application Publication
(10) Pub. No.: US 2023/0186263 A1
(43) Pub. Date: Jun. 15, 2023

(54) Digital content management

(71) Applicant: Projector, LLC., Chagrin Falls, OH (US)

(72) Inventors: Robert Marks, Chagrin Falls, OH (US); Layne Swenson, Chagrin Falls, OH (US)

(21) Appl. No.: 17/550,943

(22) Filed: Dec. 14, 2021

(51) Int. Cl. G06Q 20/12

(52) U.S. Cl. CPC G06Q 20/1235; G06Q 20/127; G06Q 2220/18; G06Q 2220/127

(57) ABSTRACT

Methods for managing digital content are provided. In one aspect, a method includes receiving a succession plan request from a first user device to initiate a succession plan to designate ownership rights to digital content owned by an owner associated with the first user device and an owner account. The method includes receiving succession information of at least one successor. The method includes determining whether payment associated with the owner account is missed. The method includes transmitting, in response to determining that payment is missed, a notification to the first user device notifying the owner that payment is missed. The method includes archiving the digital content. The method includes transmitting a first communication to the at least one successor to accept ownership of the digital content. The method includes designating ownership of the digital content to the at least one successor. System and machine-readable media are also provided.

### TECHNICAL FIELD

The present disclosure generally relates to digital media, and more specifically relates to digital content management.

### BACKGROUND

In years past, home movie videos and photographs were sometimes stored in boxes in closets or other storage areas. With the boxes packed away, often time these home movie videos and photographs would be rarely revisited. The advent of the modern digital age allowed individuals to store home movies and digitalized photographs on personal hard drives and in cloud storage. While storing the home movie videos, digital photographs, and other digital content on such personal hard drives and cloud storage provided more convenience, there is still a desire to control and manage these digital content for successive ownership.

The description provided in the background section should not be assumed to be prior art merely because it is mentioned in or associated with the background section. The background section may include information that describes one or more aspects of the subject technology.

### SUMMARY

According to certain aspects of the present disclosure, a computer-implemented method is provided. The method includes receiving a succession plan request from a first user device to initiate a succession plan to designate ownership rights to digital content owned by an owner associated with the first user device and an owner account. The method includes receiving succession information of at least one successor. The method includes determining whether payment associated with the owner account is missed. The method includes transmitting, in response to determining that payment associated with the owner account is missed, a notification to the first user device notifying the owner that payment is missed. The method includes archiving, based on a determination that an owner response to the notification is absent, the digital content. The method includes transmitting, after a predetermined period of time of unresponsiveness of the owner response, a first communication to the at least one successor to accept ownership of the digital content. The method includes designating, in response to acceptance of the first communication to the at least one successor to accept ownership of the digital content, ownership of the digital content to the at least one successor.

According to other aspects of the present disclosure, a system is provided. The system includes a memory comprising instructions and a processor configured to execute the instructions which, when executed, cause the processor to receive a succession plan request from a first user device to initiate a succession plan to designate ownership rights to digital content owned by an owner associated with the first user device and an owner account. The processor is configured to execute the instruction which, when executed, cause the processor to receive succession information of at least one successor. The processor is configured to execute the instruction which, when executed, cause the processor to determine whether payment associated with the owner account is missed. The processor is configured to execute the instruction which, when executed, cause the processor to transmit, in response to determining that payment associated with the owner account is missed, a notification to the first user device notifying the owner that payment is missed. The processor is configured to execute the instruction which, when executed, cause the processor to archive, based on a determination that an owner response to the notification is absent, the digital content. The processor is configured to execute the instruction which, when executed, cause the processor to transmit, after a predetermined period of time of unresponsiveness of the owner response, a first communication to the at least one successor to accept ownership of the digital content. The processor is configured to execute the instruction which, when executed, cause the processor to designate, in response to acceptance of the first communication to the at least one successor to accept ownership of the digital content, ownership of the digital content to the at least one successor.

According to other aspects of the present disclosure, a non-transitory machine-readable storage medium comprising machine-readable instructions for causing a processor to execute a method is provided. The method includes receiving a succession plan request from a first user device to initiate a succession plan to designate ownership rights to digital content owned by an owner associated with the first user device and an owner account. The method includes receiving succession information of at least one successor. The method includes determining whether payment associated with the owner account is missed. The method includes transmitting, in response to determining that payment associated with the owner account is missed, a notification to the first user device notifying the owner that payment is missed. The method includes archiving, based on a determination that an owner response to the notification is absent, the digital content. The method includes transmitting, after a predetermined period of time of unresponsiveness of the owner response, a first communication to the at least one successor to accept ownership of the digital content. The method includes designating, in response to acceptance of the first communication to the at least one successor to accept ownership of the digital content, ownership of the digital content to the at least one successor.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture for managing digital content, according to certain aspects of the disclosure.

FIG. 2A is a block diagram illustrating an example system of servers and devices from FIG. 1, according to certain aspects of the disclosure.

FIG. 2B is a block diagram illustrating an alternative example system of servers and devices from FIG. 1, according to certain aspects of the disclosure.

FIG. 3 illustrates an example process for managing digital content using the example management servers of either FIGS. 2A and 2B.

FIG. 4 illustrates another example process for managing digital content using the example management servers of either FIGS. 2A and 2B.

FIG. 5 is a block diagram illustrating an example computer system with which the management server, the at least one user device, and the distribution server can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

### General Overview

The disclosed systems and methods provide management of digital content. With technology increasing the convenience to easily create digital content such as, for example, videos and photos captured on mobile devices and from converting tangible home movie videos and photographs, digital storage of such digital content on personal hard drives and cloud storage has also increased. The owner of such personal digital content would previously be limited to viewing and sharing the digital content on the owner's personal devices. The disclosed systems and methods, however, provide solutions to store such personal digital content and allow access to group members to stream the personal digital content on a group member's own personal device.

The disclosed systems and methods provide improvements to digital content management by customizing organization of, and access to, the digital content. Furthermore, the disclosed systems and methods provide improvements to digital content management by creating management functions to allow a succession plan to designate ownership of the digital content. For example, an owner of the digital content stored in a cloud storage can create a succession plan to designate ownership of the digital content to a successor.

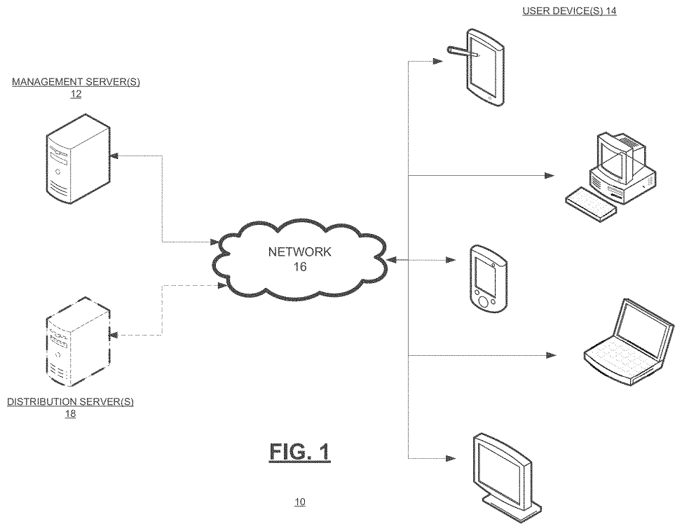

FIG. 1 illustrates an example architecture 10 for managing digital content. The architecture 10 includes a management server 12 and at least one user device 14 connected over a network 16. The management server 12 is configured to manage and control distribution of digital content. The management server 12 can be any device having an appropriate processor, memory, and communications capabilities. Each user device of the at least one user device 14 to which the management server 12 is connected over the network 16 can be, for example, a desktop computer, a mobile computer, a tablet computer (e.g., including e-book readers), a mobile device (e.g., a smartphone or PDA), a set top box (e.g., for a television), a video game console, or any other device having appropriate processor, memory, and communications capabilities. In certain aspects, the management server 12 can be a cloud computing server of an infrastructure-as-a-service (IaaS) and be able to support a platform-as-a-service (PaaS) and software-as-a-service (SaaS) services.

The network 16 can include, for example, any one or more of a personal area network (PAN), a local area network (LAN), a campus area network (CAN), a metropolitan area network (MAN), a wide area network (WAN), a broadband network (BBN), the Internet, and the like. Further, the network 16 can include, but is not limited to, any one or more of the following network topologies, including a bus network, a star network, a ring network, a mesh network, a star-bus network, tree or hierarchical network, and the like.

While the management server 12 is illustrated as one server, it should be understood that the management server 12 may include multiple servers. In certain aspects, the management server 12 is configured to host a copy of the digital content. In certain other aspects, the example architecture 10 includes at least one distribution server 18 (illustrated in FIG. 1 in phantom lines), which is configured to host a copy of the digital content.

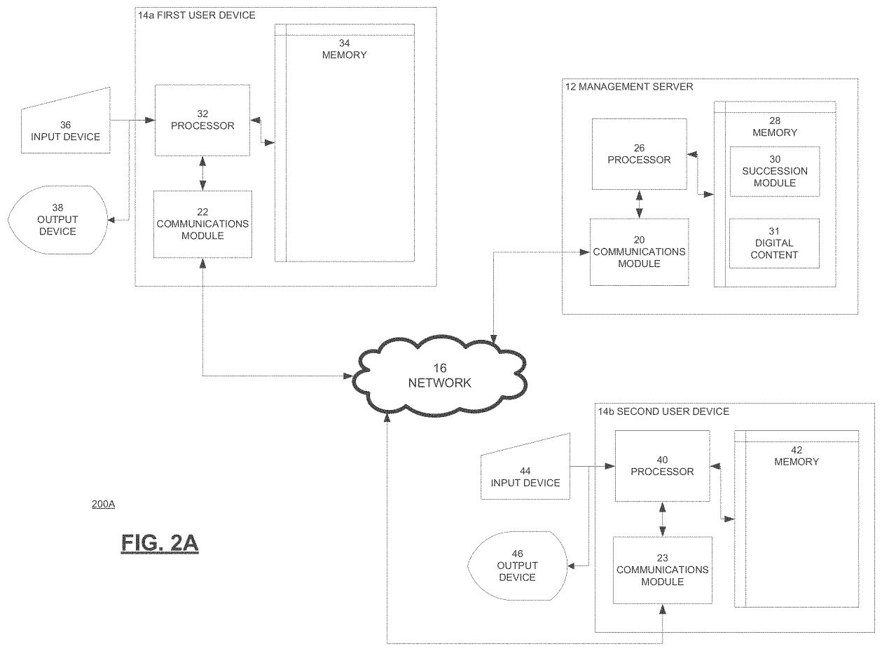

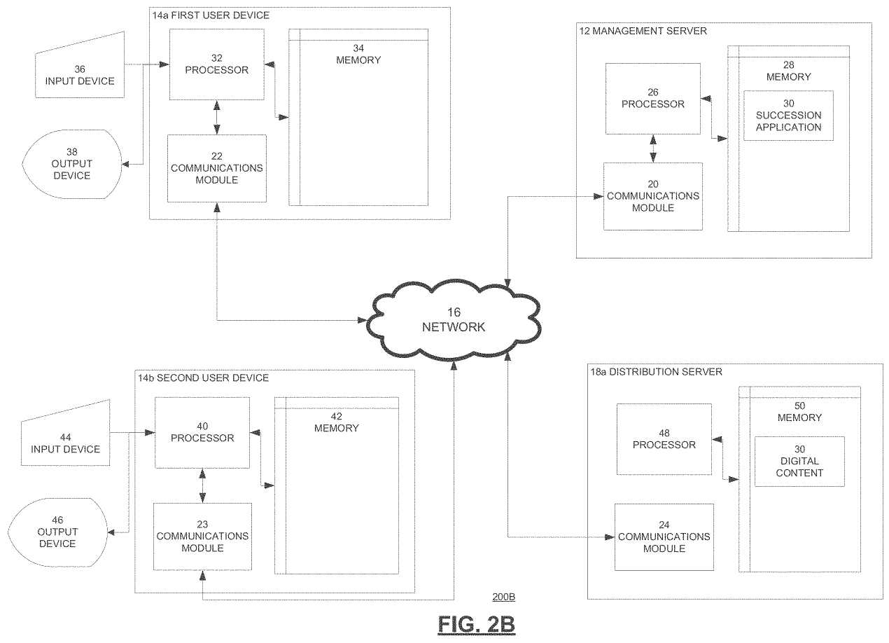

FIG. 2A is a block diagram of an example system 200A illustrating examples of the management server 12, and a first user device 14a (e.g., an owner device) and a second user device 14b of the at least one user device 14 in the example architecture 10 of FIG. 1, according to certain aspects of the disclosure. FIG. 2B is a block diagram of an alternative example system 200B illustrating the examples of the management server 12 and the first user device 14a and the second user device 14b of the at least one user device 14 in communication with a distribution server 18a of the at least one distribution server 18, according to certain aspects of the disclosure.

The management server 12, the first user device 14a of the at least one user device 14, the second user device 14b of the at least one user device 14, and in certain aspects, the distribution server 18a of the at least one distribution server 18, are connected over the network 16 via respective communication modules 20, 22, 23, 24. The communications modules 20, 22, 23, 24 are configured to interface with the network 16 to send and receive information, such as data, requests, responses, and commands to other devices on the network 16. The communications modules 20, 22, 23, 24 can be, for example, modems or Ethernet cards.

The management server 12 includes a processor 26, the communications module 20, and a memory 28 that includes a succession module 30. The processor 26 of the management server 12 is configured to execute instructions, such as instructions physically coded into the processor 26, instructions received from software in the memory 28, or a combination of both. For example, the processor 26 of the management server 12 executes instructions causing the processor 26 to perform functions to receive and store digital content 31.

The first user device 14a of the at least one user device 14 includes a processor 32, the communications module 22, and a memory 34. The first user device 14a also includes an input device 36, such as a screen interface, a keyboard, or a mouse, and an output device 38, such as a display. The processor 32 of the first user device 14a is configured to execute instructions, such as instructions physically coded into the processor 32, instructions received from software in memory 34, or a combination of both. For example, the processor 32 of the first user device 14a executes instructions causing the processor 32 to perform functions.

The second user device 14b of the at least one user device 14 includes a processor 40, the communications module 23, and a memory 42. The second user device 14b also includes an input device 44, such as a screen interface, a keyboard, or a mouse, and an output device 46, such as a display. The processor 40 of the second user device 14b is configured to execute instructions, such as instructions physically coded into the processor 40, instructions received from software in the memory 42, or a combination of both. For example, the processor 40 of the second user device 14b executes instructions causing the processor 40 to perform functions.

In certain aspects, the distribution server 18a of the at least one distribution server 18 includes a processor 48, the communications module 24, and a memory 50. The processor 48 of the distribution server 18a is configured to execute instructions, such as instructions physically coded into the processor 48, instructions received from software in the memory 50, instructions received from software in the memory 28 of the management server 12, or any combination. For example, the processor 50 of the distribution server 18a executes instructions causing the processor 50 to perform functions.

The techniques described herein may be implemented as method(s) that are performed by physical computing device(s); as one or more non transitory computer-readable storage media storing instructions which, when executed by computing device(s), cause performance of the method(s); or, as physical computing device(s) that are specially configured with a combination of hardware and software that causes performance of the method(s).

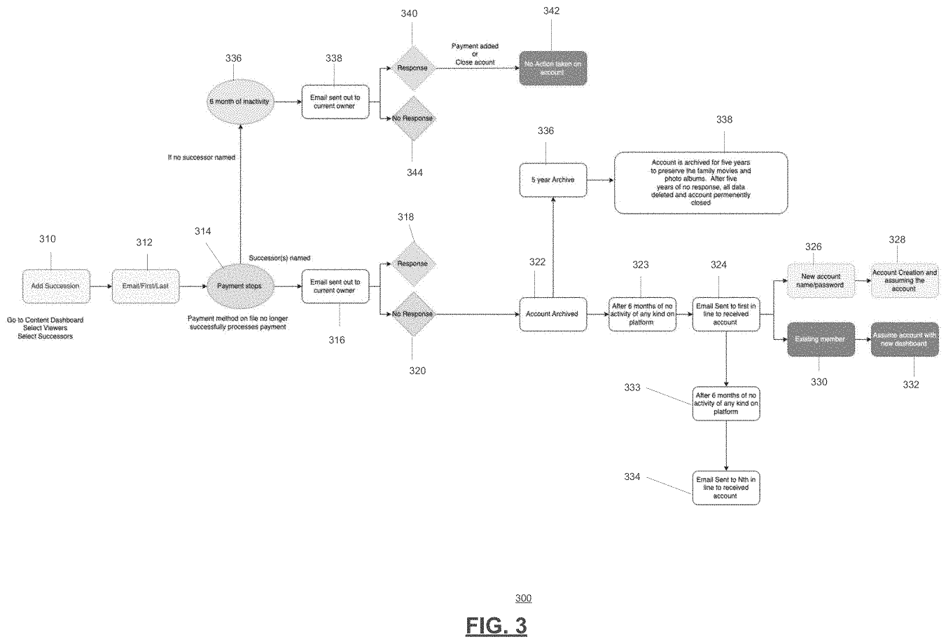

FIG. 3 illustrates an example process 300 for managing digital content using either of the management servers of FIGS. 2A and 2B. While FIG. 3 is described with reference to FIGS. 2A and 2B, it should be noted that the process steps of FIG. 3 may be performed by other systems.

The process begins by proceeding to step 310 when the processor 26 of the management server 12 receives a succession plan request from the first user device 14a of the at least one user device 14 to initiate a succession plan to designate ownership rights to the digital content 31 stored at the management server 12 or, in certain aspects, stored at the distribution server 18a. The first user device 14a is associated with the owner of the digital content 31. The owner of the digital content 31, via the first user device 14a, selects successors of the succession plan, which is transmitted to the processor 26 of the management server 12. As illustrated at step 312, the succession module 30 then receives succession information of the at least one successor from the first user device 14a. In certain aspects, the succession information includes information of at least one successor including, but not limited to, first name, last name, and email address.

As depicted in step 314, the processor 26 monitors payments of an account associated with the owner of the digital content 31 and determines whether a payment has been missed. For example, in certain aspects, the processor 26 monitors when the payment method (e.g., credit card, online payment system, and other well-known methods in the industry) on file no longer successfully processes for payment. When the processor 26 determines that payment has stopped (e.g., a payment has been missed), the processor 26 transmits a notification, such as, for example, an email, to the owner (e.g., the first user device 14a) of the digital content 31 associated with the account, as depicted at step 316. In certain aspects, the notification notifies the owner that payment has been missed. When the processor 26 receives a response in reply to the notification, the account will remain open (if payment is made) or will be closed (if requested by the owner), as depicted at step 318. On the other hand, if the processor 26 does not receive a response in reply to the notification, as depicted at step 320, then the processor 26 archives the account, as depicted at step 322, in a memory such as the memory 28 of the management server 12, the memory 50 of the distribution server 18a, or any other appropriate memory.

After the account is archived, the processor 26 monitors account activity, as depicted at step 323. When the processor 26 determines that no account activity has taken place for a period of time (e.g., 6 months or any other predetermined amount of time), the processor 26 transmits a first communication, such as an email, for example, to a first successor (e.g., second user device 14b) of the at least one successor to accept ownership on the digital content 31, as depicted at step 324. Upon acceptance of ownership of the digital content 31, if the first successor is not an existing member, the processor 26 will receive a new account name and password from the first successor (via the second user device 14b, for example), as depicted at step 326, and a new account is created for the first successor with the first successor assuming ownership of the digital content 31, as depicted at step 328. In the event that the processor 26 determines that the first successor is an existing member, as depicted at step 330, then upon acceptance of ownership of the digital content 31, the processor 26 creates a new dashboard for the digital content 31 and designates ownership of the digital content 31 to the first successor.

If the processor 26 instead receives reply from the first successor (via the second user device 14b, for example) declining acceptance of ownership of the digital content 31 of or determines that no activity has taken place on the account for a period of time (e.g., 6 months or any other predetermined period of time), as depicted at step 333, then the processor 26 transmits a second communication to the next in line successor (e.g., nth in line successor) to accept ownership of the digital content 31, as depicted at step 334. In certain aspects, the second communication is sent after six months of not receiving a reply to the first communication. When the next in line successor accepts ownership, the processor 26 proceeds to steps 326 and 328 if the next in line successor is not an existing member (e.g., membership status is non-member) or proceeds to steps 330 and 332 if the next in line successor is an existing member (e.g., membership status is member). On the other hand, if the next in line successor declines ownership, then the processor 26 continues to transmit a third communication to the second next in line successor. The processor 26 will continue to transmit communications to the next in successor until acceptance of ownership of the digital content 31 is accepted. In the event that ownership of the digital content 31 is not accepted and a predetermined period of time (e.g., five years or any other predetermined period of time) has lapsed, then the account is permanently closed and the digital content 31 is deleted, as depicted at steps 336 and 338.

Moving back to step 314, in certain aspects, when the processor 26 determines that payment has been missed for the account associated with the owner, that no successor has been named, and that there is six months of inactivity on the account, as depicted at step 336, the processor 26 transmits a notification to owner (e.g., the first user device 14a) notifying the owner that payment has been missed, as depicted at step 338. When the processor 26 receives a response in reply to the notification, as depicted at step 340, the account will remain open (if payment is made), as depicted at step 342. On the other hand, if the processor 26 does not receive a response in reply to the notification, the account is closed, as depicted at step 344.

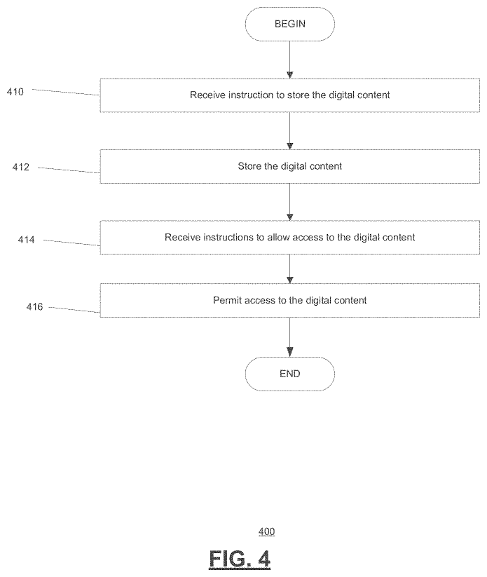

FIG. 4 illustrates an example process 400 for managing digital content using either of the management servers of FIG. 2A. While FIG. 4 is described with reference to FIG. 2A, it should be noted that the process steps of FIG. 4 may be performed by other systems.

The process begins by proceeding to step 410 when the processor 26 of the management server 12 receives instructions to store the digital content 31 from the first user device 14a. As depicted at step 412, the processor 26 of the management server 12 stores the digital content 31 in memory 28 at the management server 12. The processor 26 of the management server 12 receives instructions from the first user device 14a to allow the second user device 14b access to the digital content 31, as depicted at step 414. In response to receiving a request to access the digital content 31 from the second user device 14b, the processor 26 permits the second user device 14b to access the digital content 31.

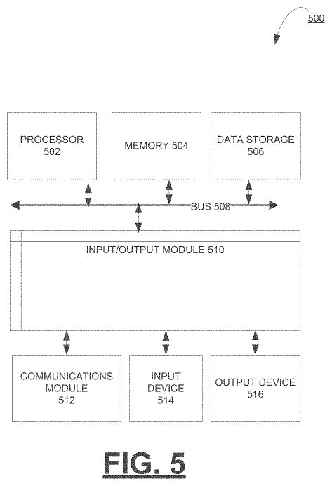

FIG. 5 is a block diagram illustrating an example computer system 500 with which the management server 12, the at least one user device 14 (e.g., the first user device 14a and the second user device 14b), and the at least one distribution server 18 (e.g., the distribution server 18a) of FIGS. 2A and 2B can be implemented. In certain aspects, the computer system 500 may be implemented using hardware or a combination of software and hardware, either in a dedicated server, or integrated into another entity, or distributed across multiple entities.

Computer system 500 (e.g., the management server 12, the at least one user device 14 (the first user device 14a and the second user device 14b), and the at least one distribution server 18 (the distribution server 18a)) includes a bus 508 or other communication mechanism for communicating information, and a processor 502 (e.g., the processor 26, 32, 40, 48) coupled with bus 508 for processing information. According to one aspect, the computer system 500 can be a cloud computing server of an IaaS that is able to support PaaS and SaaS services.

Computer system 500 can include, in addition to hardware, code that creates an execution environment for the computer program in question, e.g., code that constitutes processor firmware, a protocol stack, a database management system, an operating system, or a combination of one or more of them stored in an included memory 504 (e.g., the memory 28, 34, 42, 50), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, e.g., one or more modules of computer program instructions encoded on a computer readable medium for execution by, or to control the operation of, the computer system 500.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network, such as in a cloud-computing environment. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices (e.g., the input device 36, 44 the output device 38, 46). The input/output module 510 can be any input/output module. Example input/output modules 510 include data ports such as USB ports. In addition, input/output module 510 may be provided in communication with processor 502, so as to enable near area communication of computer system 500 with other devices. The input/output module 510 may provide, for example, for wired communication in some implementations, or for wireless communication in other implementations, and multiple interfaces may also be used. The input/output module 510 is configured to connect to a communications module 512. Example communications modules 512 (e.g., the communications module 20, 22, 23, 24) include networking interface cards, such as Ethernet cards and modems.

In certain aspects, the input/output module 510 is configured to connect to a plurality of devices, such as an input device 514 (e.g., the input device 36, 44) and/or an output device 516 (e.g., the output device 38, 46). Example input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device.

According to one aspect of the present disclosure, the management server 12, the at least one user device 14 (e.g., the first user device 14a and the second user device 14b), and the at least one distribution server 18 (e.g., the distribution server 18a) can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein. One or more processors in a multi-processing arrangement may also be employed to execute the sequences of instructions contained in memory 504. Processor 502 may process the executable instructions and/or data structures by remotely accessing the computer program product, for example by downloading the executable instructions and/or data structures from a remote server through communications module 512 (e.g., as in a cloud-computing environment). In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. For example, some aspects of the subject matter described in this specification may be performed on a cloud-computing environment. Accordingly, in certain aspects a user of systems and methods as disclosed herein may perform at least some of the steps by accessing a cloud server through a network connection. Further, data files, circuit diagrams, performance specifications and the like resulting from the disclosure may be stored in a database server in the cloud-computing environment, or may be downloaded to a private storage device from the cloud-computing environment.

The term “machine-readable storage medium” or “computer-readable medium” as used herein refers to any medium or media that participates in providing instructions or data to processor 502 for execution. The term “storage medium” as used herein refers to any non-transitory media that store data and/or instructions that cause a machine to operate in a specific fashion. Such a medium may take many forms, including, but not limited to, non-volatile media, volatile media, and transmission media.

As used in this specification of this application, the terms “computer-readable storage medium” and “computer-readable media” are entirely restricted to tangible, physical objects that store information in a form that is readable by a computer. These terms exclude any wireless signals, wired download signals, and any other ephemeral signals. Storage media is distinct from but may be used in conjunction with transmission media. Transmission media participates in transferring information between storage media. For example, transmission media includes coaxial cables, copper wire and fiber optics, including the wires that comprise bus 508. Transmission media can also take the form of acoustic or light waves, such as those generated during radio-wave and infra-red data communications. Furthermore, as used in this specification of this application, the terms “computer”, “server”, “processor”, and “memory” all refer to electronic or other technological devices. These terms exclude people or groups of people. For the purposes of the specification, the terms display or displaying means displaying on an electronic device.

In one aspect, a method may be an operation, an instruction, or a function and vice versa. In one aspect, a clause or a claim may be amended to include some or all of the words (e.g., instructions, operations, functions, or components) recited in other one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for”.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A computer-implemented method for managing digital content, the computer-implemented method comprising:
receiving a succession plan request from a first user device to initiate a succession plan to designate ownership rights to digital content owned by an owner associated with the first user device and an owner account;
receiving succession information of at least one successor;
determining whether payment associated with the owner account is missed;
transmitting, in response to determining that payment associated with the owner account is missed, a notification to the first user device notifying the owner that payment is missed;
archiving, based on a determination that an owner response to the notification is absent, the digital content;
transmitting, after a predetermined period of time of unresponsiveness of the owner response, a first communication to the at least one successor to accept ownership of the digital content; and
designating, in response to acceptance of the first communication to the at least one successor to accept ownership of the digital content, ownership of the digital content to the at least one successor.

2. The computer-implemented method of claim 1, further comprising:
determining, in response to the acceptance of the first communication, a membership status of the at least one successor; and
creating, responsive to a determination that the membership status of the at least one successor is non-member, a successor account associated with the at least one successor and the owner account.

3. A computer-implemented method of claim 1, further comprising:
determining, in response to the acceptance of the communication, a membership status of the at least one successor; and
associating, responsive to a determination that the membership status of the at least one successor is member, a member account of the at least one successor with the owner account.

4. A computer-implemented method of claim 1, further comprising:
transmitting, in response to determining that the first communication to the at least one successor to accept ownership of the digital content is declined, a second communication to a next in line successor of the at least one successor to accept ownership of the digital content; and
designating, in response to acceptance of the second communication to the next in line successor of the at least one successor to accept ownership of the digital content, ownership of the digital content to the next in line successor of the at least one successor.

5. A computer-implemented method of claim 4, further comprising:
transmitting, in response to determining that the second communication to the next in line successor of the at least one successor to accept ownership of the digital content is declined, a third communication to a nth in line successor of the at least one successor to accept ownership of the digital content; and
designating, in response to acceptance of the third communication to a nth in line successor of the at least one successor to accept ownership of the digital content, ownership of the digital content to the nth in line successor of the at least one successor.

6. A computer-implemented method of claim 1, further comprising:
deleting, after a predetermined period of time of account inactivity, the digital content.

7. A computer-implemented method of claim 1, wherein the predetermined period of time of account inactivity is five years.

8. A computer-implemented method of claim 1, wherein the predetermined period of time of unresponsiveness of the owner response is six months.

9. A system for managing digital content, the system comprising:
a memory comprising instructions; and
a processor configured to execute the instructions which, when executed, cause the processor to:
receive a succession plan request from a first user device to initiate a succession plan to designate ownership rights to digital content owned by an owner associated with the first user device and an owner account;
receive succession information of at least one successor;
determine whether payment associated with the owner account is missed;
transmit, in response to determining that payment associated with the owner account is missed, a notification to the first user device notifying the owner that payment is missed;
archive, based on a determination that an owner response to the notification is absent, the digital content;
transmit, after a predetermined period of time of unresponsiveness of the owner response, a first communication to the at least one successor to accept ownership of the digital content; and
designate, in response to acceptance of the first communication to the at least one successor to accept ownership of the digital content, ownership of the digital content to the at least one successor.

10. The system of claim 9, wherein the processor is configured to execute the instructions which, when executed, cause the processor to:
determine, in response to the acceptance of the first communication, a membership status of the at least one successor; and
create, responsive to a determination that the membership status of the at least one successor is non-member, a successor account associated with the at least one successor and the owner account.

11. The system of claim 9, wherein the processor is configured to execute the instructions which, when executed, cause the processor to:
determine, in response to the acceptance of the communication, a membership status of the at least one successor; and
associate, responsive to a determination that the membership status of the at least one successor is member, a member account of the at least one successor with the owner account.

12. The system of claim 9, wherein the processor is configured to execute the instructions which, when executed, cause the processor to:
transmitting, in response to determining that the first communication to the at least one successor to accept ownership of the digital content is declined, a second communication to a next in line successor of the at least one successor to accept ownership of the digital content; and
designating, in response to acceptance of the second communication to the next in line successor of the at least one successor to accept ownership of the digital content, ownership of the digital content to the next in line successor of the at least one successor.

13. The system of claim 12, wherein the processor is configured to execute the instructions which, when executed, cause the processor to:
transmitting, in response to determining that the second communication to the next in line successor of the at least one successor to accept ownership of the digital content is declined, a third communication to a nth in line successor of the at least one successor to accept ownership of the digital content; and
designating, in response to acceptance of the third communication to a nth in line successor of the at least one successor to accept ownership of the digital content, ownership of the digital content to the nth in line successor of the at least one successor.

14. The system of claim 9, wherein the processor is configured to execute the instructions which, when executed, cause the processor to:
delete, after a predetermined period of time of account inactivity, the digital content.

15. The system of claim 9, wherein the predetermined period of time of account inactivity is five years.

16. The system of claim 9, wherein the predetermined period of time of unresponsiveness of the owner response is six months.

17. A non-transitory machine-readable storage medium comprising machine-readable instructions for causing a processor to execute a method for managing digital content, the method comprising:
receiving a succession plan request from a first user device to initiate a succession plan to designate ownership rights to digital content owned by an owner associated with the first user device and an owner account;
receiving succession information of at least one successor;
determining whether payment associated with the owner account is missed;
transmitting, in response to determining that payment associated with the owner account is missed, a notification to the first user device notifying the owner that payment is missed;
archiving, based on a determination that an owner response to the notification is absent, the digital content;
transmitting, after a predetermined period of time of unresponsiveness of the owner response, a first communication to the at least one successor to accept ownership of the digital content; and
designating, in response to acceptance of the first communication to the at least one successor to accept ownership of the digital content, ownership of the digital content to the at least one successor.

18. The non-transitory machine-readable storage medium of claim 17, further comprising:
transmitting, in response to determining that the first communication to the at least one successor to accept ownership of the digital content is declined, a second communication to a next in line successor of the at least one successor to accept ownership of the digital content; and
designating, in response to acceptance of the second communication to the next in line successor of the at least one successor to accept ownership of the digital content, ownership of the digital content to the next in line successor of the at least one successor.

19. The non-transitory machine-readable storage medium of claim 18, further comprising:
transmitting, in response to determining that the second communication to the next in line successor of the at least one successor to accept ownership of the digital content is declined, a third communication to a nth in line successor of the at least one successor to accept ownership of the digital content; and
designating, in response to acceptance of the third communication to a nth in line successor of the at least one successor to accept ownership of the digital content, ownership of the digital content to the nth in line successor of the at least one successor.

20. The non-transitory machine-readable storage medium of claim 17, further comprising:
deleting, after a predetermined period of time of account inactivity, the digital content.
